(19) United States
(12) Patent Application Publication
(10) Pub. No.: US 2018/0322543 A1
(43) Pub. Date: Nov. 8, 2018

(54) System and Method for Healthcare Donations using a Private Distributed Ledger

(71) Applicant: David Graybill, Phoenix, AZ (US)

(72) Inventor: David Graybill, Phoenix, AZ (US)

(21) Appl. No.: 15/968,588

(22) Filed: May 1, 2018

Related U.S. Application Data
(60) Provisional application No. 62/500,415, filed on May 2, 2017.

(51) Int. Cl. G06Q 30/02; G06Q 20/06; G06Q 20/34; G06Q 50/00

(52) U.S. Cl. CPC G06Q 30/0279; G06Q 50/01; G06Q 20/349; G06Q 20/06

(57) ABSTRACT

The embodied invention is a system whereby healthcare funds (healthcare credits) are raised from a variety of sources and accumulated in a healthcare funding account specifically designated for an individual's healthcare expenses. A smart phone application is used to transfer financial support to the designated individual's funding account from other financial institutions (banking accounts).

The donors to a specific funding account can be anyone or company who participates in the healthcare funding system. They can be individuals, groups, charities, merchants, employers, corporate sponsors, and trust funds.

An individual health care funding account is set up by use of a website and a login account.

### CROSS REFERENCE TO RELATED APPLICATIONS

This application claims the benefit of U.S. provisional application No. 62/500,415 filed on May 2, 2017. The US provisional application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

### (1) Field of the Invention

This invention is directed toward methods of providing healthcare through alternate financial sources such as crowdfunding, donations, and public requests for money.

### (2) Description of Related Art

Individuals throughout the US have difficulty with obtaining access to healthcare when under financial duress. For example, there are numerous fundraising efforts throughout the country to obtain funds for individuals to pay for accidents, medical expenses related to unexpected illness, and when medical insurance is lost.

Personal fundraising on a very local level has been a way to help someone in need. This can be supported by a variety of fundraising ideas such as bake sales, passing the hat in a group, door to door request for donations, raffles, food sales, white elephant sales, etc.

More recently, fundraising efforts includes crowdfunding. An online posting requesting funds can appeal to a wide variety of individuals and companies, requesting money. Websites such as gofundme.com provide a way for an individual or a group to donate to a person's medical expenses, along with other financial needs someone in need may have.

However, these efforts are generally one time donations. Such methods of fundraising do not provide for a routine way of sending money to an individual's need for ongoing healthcare without the broadcasting effort to request a one-time donation. Such efforts do not help a person with smaller, ongoing expenses such as paying routine premiums for healthcare insurance.

US publication number 20150161614 describes a system for processing donations into multiple accounts. Authorized administrators review the accounts, and a system member is able to view applications, and make comments to address issues related to dishonest behavior. Also, a voting system is created for approval of applications. However, this system lacks financial accountability as to allowing the donors to confirm where the funds are ultimately spent.

A barrier for providing healthcare assistance with distressed individuals is the lack of transparency in how the money is spent. Some charity funding websites are setup to help individuals with urgent medical expenses, but lack accountability to the donors as to whether the money actually went to medical expenses. It is possible that donated money is directed toward other personal items as chosen by the recipient. This lack of transparency is a hindrance to potential donations by donors who are concerned with ensuring the money is used for the intended purpose.

As part of their framework, foundations often have a policy that requires 2-3% of funds to be spent on charity funding. Providing healthcare for individuals in need is an appealing endeavor for charity spending. However, to date there has been no succinct way to track donation spending. It is important that foundations have confidence that money donated is used for the intended purpose. A foundation's board of directors will be less reluctant to provide assistance to a wide variety of needy individuals if their funds are trackable. Donating locally to individuals in the community could then become a part of a foundation's giving portfolio rather than donating solely to larger, well run charity organizations.

Traditional donor platforms include donating money to a charitable non-profit company, who in turn, provide assistance to needy individuals or other charitable organizations. Donors rely upon charity company reports of how money is distributed, and how much of the donation is used for non-profit company operational support.

Alternatively, a donor may directly donate money to an individual in need of financial help. This is a peer to peer donation.

In both cases, donors have no way to verify how their donation has been spent and who has received benefits. Donors have to rely on NPO reports or the honesty of an individual receiving help. In a charity company, sometimes multiple individuals receive assistance from a single donation which cannot be individually tracked. Third party audits have to rely on charitable company reports.

Donors cannot strictly enforce allocation of funds a particular charitable purpose. Currently, in peer to peer donations, the donor has little or no control over money is spent.

Healthcare costs are rising and are expected to continue to rise. It is important that healthcare support is routine and sustainable.

### BRIEF SUMMARY OF THE INVENTION

The embodied invention is a system whereby healthcare funds (healthcare credits) are raised from a variety of sources and accumulated in a healthcare funding account specifically designated for an individual's healthcare expenses. Easy transfer of funding is provided by a smart phone and/or web application.

Donors to an individual's health care funding account are able to review that the donated money is spent for its intended use by reviewing the transactions in a private block chain, where their donated money is recorded in a block chain ledger.

### BRIEF DESCRIPTION OF THE SEVERAL VIEWS OF THE DRAWING(S)

FIG. 1 shows a current art of donation fund flows.

FIG. 2 shows a digital private health care network for giving/donating.

FIG. 3 shows additional details of the digital private health care network for giving/donating.

FIG. 4 points out additional features of the digital private healthcare network.

### DETAILED DESCRIPTION OF THE INVENTION

It is philanthropically important to be able to financially support people in need of assistance with out of pocket medical expenses. Additionally, it is important to facilitate the confident transfer of funds from individuals, groups, organizations, businesses, families, and friends to someone in need with out of pocket medical expenses; and to assure that the funds are used for their intended purpose.

It is known that there are individuals, groups, charities, merchants, and corporate sponsors who desire to be philanthropic. It is a primary objective of the embodied invention to facilitate financial connection with donors and individuals in need of financial assistance, where the transactions are transparent, and the receiver of funds is accountable.

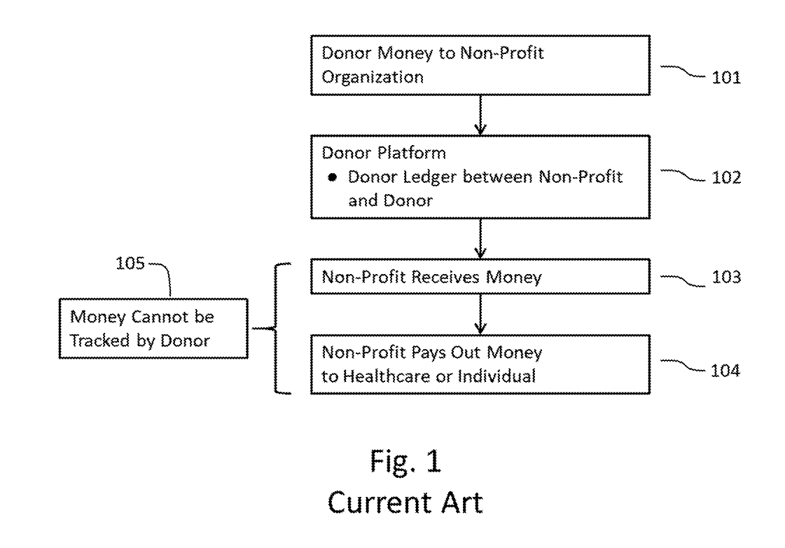

FIG. 1 shows the current flow chart for donating to a non-profit organization and the lack of transparency:
101 A donor donates money to the non-profit organization (NPO).
102 The donation is recorded by the NPO in a donor ledger
103 The NPO receives the donated money.
104 The NPO pays money to merchant or individual
105 The money cannot be tracked by the donor. Key issues are:
   1. Lack of visibility on the use of funds
   2. No control over the application of funds to a particular purpose
   3. Significant financial losses due to fund expenditures between the source and the final destination.

### Solution

The embodied invention utilizes a distributed, digital private health care network that is designed, configured, and managed to connect donors and individuals in need. A health care network that facilitates managing healthcare funding accounts for both individuals in need and donors.

The conceived invention addresses the short comings in the current art (FIG. 1) and provides additional benefits.

The conceived invention uses a private blockchain distributed ledger system. The blockchain distributed ledger in a single system that manages all data in a secure, immutable, and transparent manner. The blockchain distributed ledger is used to track the origin of a donation, the amount, and the movement of the money from one place to another.

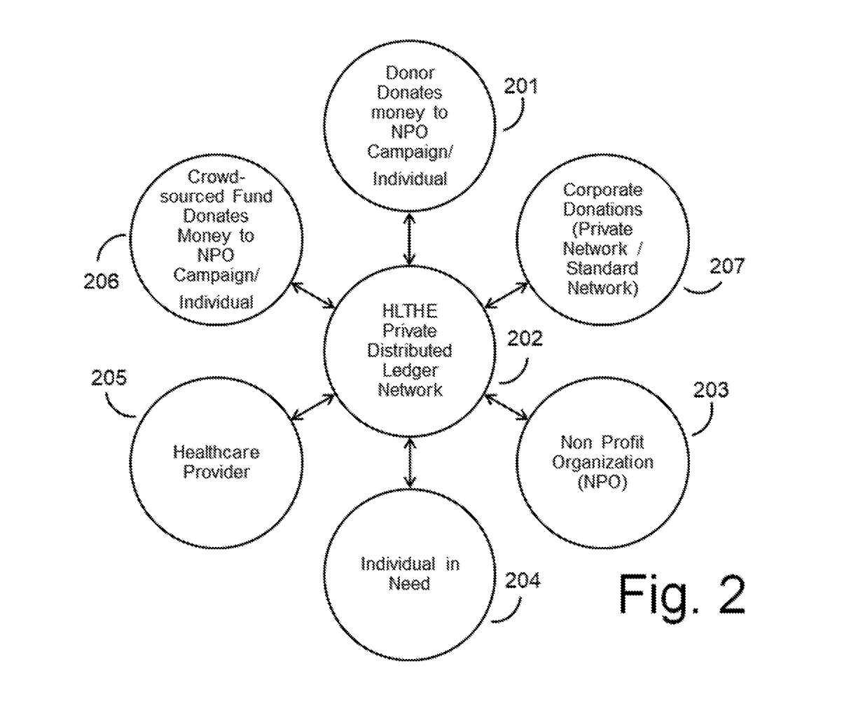

FIG. 2 shows the embodied digital private health care network for giving/donating between donors, healthcare providers, individuals in need, and non-profit organizations:
201 Donor donates money that is directed to a non-profit organization or an individual,
202 The private, distributed healthcare network processes the donation and one or more of the following steps occurs.
203 A non-profit organization receives donated money,
204 An individual in need receives donated money,
205 A healthcare provider receives donated money,
206 Crowdsourced fund donates money to a Non-profit organization or to an individual,
207 Corporate organizations donate money to the private healthcare network.

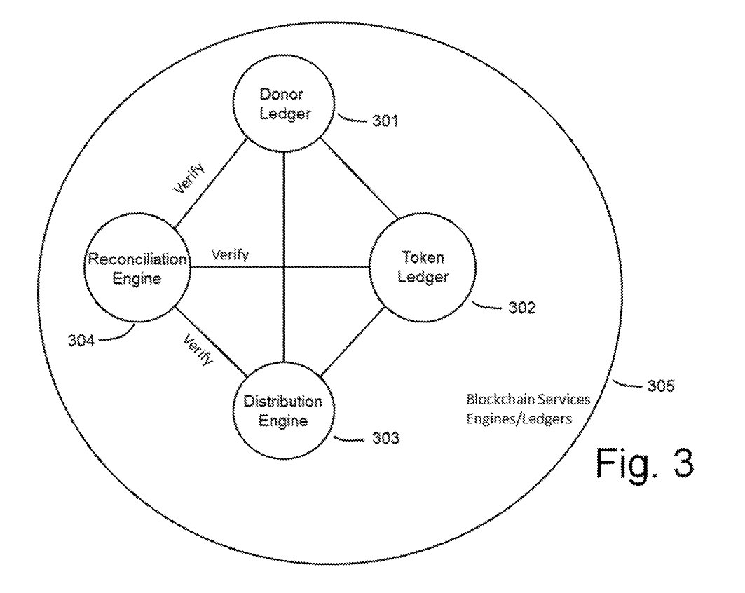

The interconnected elements of the private distributed ledger network in FIG. 3 are:
301 a donation ledger
302 a token ledger
303 a distribution engine
304 reconciliation engine—a program that verifies block chain ledger integrity

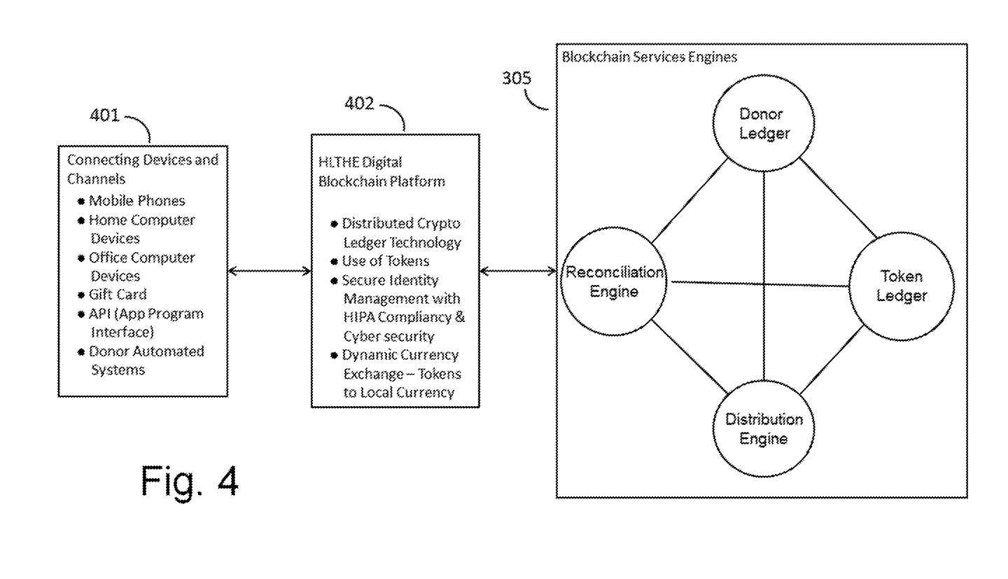

FIG. 4 points out additional features of the digital private healthcare network. The members and donors connect to the healthcare network 401 through their home or office computer, the use of an application program interface, and/or automated donation systems.

The digital blockchain program 402 utilizes distributed cryptography ledger technology, tokens, secure identity management which complies with HIPAA and cyber privacy security. It also includes a dynamic currency to token exchange based on local currency and current prices.

It is generally conceived that the individuals, donors, non-profit organizations, corporate companies, health care providers, and crowd sourced funding will access the healthcare network through a dedicated interface program, or through a website page on the Internet. Other website pages (such as a healthcare provider page) may direct individuals via an internet link to the private healthcare network website page.

All donor donations are recorded in distributed ledger in a token donation currency. The donated money is converted to cash tokens and are assigned to a non-profit organization (NPO) or an individual to whom the donation is made. Conversions and assignments are done using features available in Blockchain technologies.

Each cash token represents the smallest denomination of a local currency. For example, in the US, one token represents 1 cent in US currency.

A fund payout system (within the distribution engine) provides for converting tokens to cash and then issues the cash to the healthcare provider as directed by the donor.

An NPO is able to donate NPO tokens to individuals who are in need of help.

Individuals who receive cash tokens can get services from Merchants (such as a healthcare provider) and pay any balance due in tokens. The cash tokens effectively pay a merchant equivalent money.

In the case that a merchant doesn't accept tokens, the individual can submit the bills to the private distributed ledger network platform, and the platform pays cash to the merchant.

A NPO can request currency payments to third parties (or employee) for operational overhead. The healthcare platform directly pays to requested parties and reduces equivalent tokens from the NPO account.

A NPO is never given money and the healthcare platform tracks movement of tokens and payouts to provide full transparency.

Using blockchain transaction verification capabilities, the private healthcare network can have one or more independent organization(s) that can validate all the transactions.

The healthcare platform has a reconciliation engine which reconciles the money and tokens ledgers. The reconciliation engine is implemented in connection with the distribution engine and the two ledgers.

To facilitate financial accountability, a private block chain ledger is created for each health care funding account. The block chain ledger is designed to be tamper proof and provides accountability to the flow of cash (donations—gifts—tips) to the final place where it is spent at a healthcare provider. The ledger is set up to provide limited access to donors and patients, and the ledger is a permanent record (i.e. cannot be deleted).

The use of a private block chain ensures data integrity and transparency of cash flow. The patient and donor are given access/ID codes which are used to verify how the money is spent.

To ensure sustainability of the healthcare donation system, a small transaction fee (1-5%) is assessed to log transactions, administer the member system, and support long term sustainability.

The donation is essentially a peer to peer transaction within the donor healthcare network. The system requires that the donated money is used for health care purposes. To this end, healthcare providers join the healthcare network, and are verified as healthcare providers.

In an embodiment of the invention, an individual can add money into their healthcare funding account by transferring money from their personal bank account. This is helpful when healthcare providers offer discounts for their services through the healthcare network system.

In an embodiment of the invention, health care providers offer discounts to members with accounts. This encourages use of the accounts by both patients and providers.

In another embodiment of the invention, the funds from the individual healthcare accounts provide financial assistance with insurance copays and other medical payments that insurance does not provide, such as annual deductibles.

The system provides a registration system to add providers, donors, and patients. To facilitate easy access to the healthcare network, no sign up fee is accessed for joining. The healthcare providers are reviewed by the administrator to ensure that they are legitimate providers. Use of emails, phone numbers, addresses, medical licenses, etc. are used to verify their status.

As part of the registration process, and to assure each individual that they are accepted by the healthcare network, each individual receives a healthcare network fund account, as well as a healthcare registration card with an identification number associated with their healthcare network fund account.

To ensure that the healthcare network is not misused by individuals, the healthcare funds in the network are not transferable between patients. This avoids an individual asking for money, receiving donated funds, and then ‘selling’ their donations to another account for undocumented cash to use for personal purposes.

Under current law, all donations are considered gifts and no taxes are incurred to the extent that the amounts are below IRS guidelines.

In an embodiment, a family estate or trust can donate funds to an individual account and establish additional transfers upon the death of the trustee. Similarly, a foundation can donate funds to an individual account.

In another embodiment, a healthcare gift card can be established where a patient can load up the card and make payments to a doctor or medical care provider using the card. The transaction would be similar to a credit or debit card. Additionally, donors could give gift cards to individuals, who register the amounts on the healthcare network system by providing codes on the healthcare cards.

In another embodiment the healthcare network is compliant with current HIPAA laws.

The conceived blockchain is a continuously growing list of fund records, called blocks, which are linked and secured by cryptography. Each block refers to the previous block in a transaction chain. It is an open, distributed ledger that records transactions between two accounts in a verifiable and permanent way.

The private blockchain network requires a registration where the individual or company is validated by the network administrator using a set of rules. The blockchain is essentially a permissioned network. This places restrictions on who is allowed to participate in the network, and how certain transactions are made. Members and donors need to register and be validated to join. Once a member/donor/company has joined the network, they play a role in maintaining the blockchain in a decentralized manner.

A private blockchain has many of the advantages of a public blockchain:

1) Decentralized peer to peer network, maintaining the shared blockchain ledger

2) Use of consensus

3) Provide certain guarantees of ledger integrity

Both the donors and individuals in need become members of the charitable health care network. Funds can then be readily transferred between donors and individuals in need via that network. The members can share their financial resources (i.e. healthcare tokens) between each other. The charitable health care network is designed so that only qualified health care providers (such as doctors and hospitals) can receive financial withdrawals from the digital private health care network.

To access a user health care fund, a smart phone app, computer, or a membership card is utilized. Healthcare credits are used to pay medical bills, co-pays, prescriptions and other related healthcare expenses. This program makes it possible for every person in a local community to have help with their healthcare costs. Hospitals, urgent cares, healthcare providers, pharmacy's and even holistic health practitioners can choose to accept funding from the charitable healthcare network at the time of service for payment.

Funds in the charitable health care network are managed in an individual's funding account in the following manner or for the following purposes:
1) An individual adding to their healthcare funding account by making a direct contribution to their own account from a bank or credit card.
2) Utilize the funding account for co-pays for health care providers such as a primary care physician or a specialist.
3) Healthcare credits can be gifted to an individual, such as
   a) Grandparents to grandchildren
   b) Birthday party credits.
   c) Friend to friend.
   d) Charitable group to an individual
   e) A healthcare trust
   f) A will upon someone's death
   g) Rewards from attending a fitness center, wellness center, or gym. The program encourages a healthy life style and rewards members for making their health a priority.
   h) Large groups through fundraising. Funds donated to this account would then be transferred to help a specific member in the group for their personal healthcare needs.
   i) Parents may sign up children for the program so that they may accrue health care credits via gifting or donations throughout their lifetime.
   j) Individuals who are uninsured, under insured or unable to meet co-pays can utilize their healthcare fund account for payment.
   k) Service tips to waiter, waitress, barber, etc.

Alternately, an individual can obtain healthcare credits and/or discounts at stores and businesses and agencies by:
1) Earning store loyalty rewards that are converted to healthcare fund credits for future use by their patrons.
2) Redirecting membership fees to healthcare credits by cooperating businesses and agencies.
3) Receiving discounts from healthcare providers.

It is the goal that the healthcare credits accumulated in the healthcare funding account do not expire and are accrued and shared throughout an individual's lifetime.

The healthcare funding system guarantees that money being raised for healthcare through gifting, fund raisers and/or crowd funding is used entirely for that purpose. This is done by registering and confirming healthcare provider information before they are allowed access to funds.

Benefits of a healthcare funding account are:
1) Confirm/assure donors that money gifted is used only for the healthcare. Cash is directly sent to an individual funding account.
2) Providing grants for services in a funding account.
3) Accepting after tax donations as well as pre-tax donations.

To run the digital private health care network and funding accounts, an organization (healthcare network) is needed to keep track of funds. The healthcare network organization then is responsible for controlling and maintain the funding accounts and assure that funds meet accounting standards. To transfer money, a corporate bank account is set up to process transactions and monitor payments to providers. Standard payments are made by wire transfer or by check.

To boost signups to the digital private health care network, participating stores can contribute cash awards for individuals to sign up.

It is generally conceived in the embodied invention that normal bank transaction fees will be assessed when moving money from the individual fund to health care providers.

It is generally conceived in the embodied invention that the healthcare funding accounts will span multiple countries, and that a worldwide funding network will be created.

It is generally conceived in the embodied invention that the application program in the smart phone will include the following functions:
1. Sign up function by use of user ID and a password
2. Input/store personal contact information on the website/digital private health care network
3. Set up a user profile and establish security
4. Ability to look for healthcare providers to find needed health care
5. List a personal story when requesting funds from individuals, businesses, and crowdfunding.

It is generally conceived in the embodied invention that people who do not use a smart phone or computer, a membership card will be utilized. The card will have the name of the individual, a bar code, a magnetic stripe, and organization identification.

It is generally conceived in the embodied invention that an individual will not able to directly access the money that is stored in the funding account once it is in the system. This is to assure donors that any money that is collected will be only used for health care provider expenses.

As used herein the terms central computer and computer system are intended to refer to a computer-related entity, comprising either hardware, a combination of hardware and software, software, or software in execution capable of performing the embodiments described. The disclosed embodiments which use the central computer refer to being interfaced to and controlled by a computer readable storage medium having stored thereon a computer program. The computer readable storage medium may include a plurality of components such as one or more of electronic components, hardware components, and/or computer software components. These components may include one or more computer readable storage media that generally store instructions such as software, firmware and/or assembly language for performing one or more portions of one or more implementations or embodiments of an algorithm as discussed herein. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or solid-state or electronic memory. Other forms of non-transitory and/or tangible computer readable storage media not list may be employed with the disclosed embodiments.

A number of such components can be combined or divided in an implementation of a computer system. Further, such components may include a set and/or series of computer instructions written in or implemented with any of a number of programming languages, as will be appreciated by those skilled in the art. Computer instructions are executed by at least one central processing unit. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A method to provide personal healthcare funding through Internet donations from other individuals comprising:
A) providing:
1) a private health care network accessible through said Internet,
2) a registration system for:
1. a plurality of donors,
2. a plurality of members,
3. a plurality of non-profit organizations, and
4. a plurality of healthcare providers,
to access said private health care network through said Internet,
3) a fund account for each of:
1. said donors,
2. said member,
3. said non-profit organization, and
4. said healthcare provider,
on said private health care network,
4) a member fund payout system* on said private health care network,
5) a private blockchain comprising:
1. a donor ledger,
2. a token ledger, and
3. a reconciliation engine,
B) each donation by said donors is recorded in said donor ledger,
C) a conversion of said each donation is made to cash tokens and recorded in said token ledger,
D) said cash tokens are transferred between said fund accounts according to donation requirements,
and
E) wherein said private blockchain is monitored by a plurality of administrators,
F) wherein said reconciliation engine is used by at least one administrator.

2. The healthcare funding system according to claim 1 wherein each said member is issued a healthcare funding card with a member number on it.
